(19) United States
(12) Patent Application Publication
(10) Pub. No.: US 2026/0312060 A1
(43) Pub. Date: Oct. 8, 2026

(54) SURFACE ETCHED BATTERY ELECTRODES VIA PHASE SEPARATION

(71) Applicant: FORD GLOBAL TECHNOLOGIES, LLC, Dearborn, MI (US)

(72) Inventors: Ali Rashti, Ann Arbor, MI (US); Celia Cunningham, Northville, MI (US); Andrew Robert Drews, Ann Arbor, MI (US)

(21) Appl. No.: 19/171,679

(22) Filed: Apr. 7, 2025

(51) Int. Cl. H01M 4/62; H01M 4/04; H01M 50/46

(52) U.S. Cl. CPC H01M 4/623; H01M 4/0419; H01M 50/46

(57) ABSTRACT

An electrode includes an active material and binder, with the binder forming shell-like structures that define surface voids. In the battery, the electrode has a porous surface with elevated binder amounts at the pore edges, and a laminated separator partially fills these pores. A method involves applying a non-solvent to a wet electrode layer containing a solvent, active material, and binder. The non-solvent, miscible with the solvent but not dissolving the binder, induces phase separation, forming nucleation sites where the binder precipitates into shells, creating surface pores. These pores, initially filled with a solvent-non-solvent mixture, are emptied through drying. The process may involve spraying.

### TECHNICAL FIELD

This disclosure relates to batteries and battery manufacturing.

### BACKGROUND

A solid-state battery can include a positive electrode, a negative electrode, and a solid electrolyte, which also functions as a separator. In some examples, the positive electrode can be composed of an active material, a conductive additive, and a binder, all coated onto a current collector. The negative electrode can be made of lithium metal, a lithium alloy, or a composite of an active material, binder, and conductive additive, also coated onto a current collector. The solid electrolyte is positioned between the electrodes to enable ion transport while preventing direct contact between the positive and negative electrodes. The battery is typically assembled in a layered structure, with the solid electrolyte providing mechanical stability and ionic conductivity. The entire cell can be enclosed in a protective casing to maintain structural integrity and prevent contamination.

### BRIEF DESCRIPTION OF THE DRAWINGS

FIG. 1 is a side view, in cross section, of a battery cell.

FIG. 2 is a schematic diagram of an electrode coating process.

FIG. 3 is a plan view of an etched surface of an electrode.

FIG. 4 is a side view of an electrode and separator with surface etching.

### SUMMARY

A battery includes an electrode layer composed of an active material and a binder, with a surface structure characterized by a network of pores. The edges of these pores contain elevated amounts of the binder compared to the adjacent electrode areas. A separator is laminated onto the electrode layer, with portions of the separator at least partially filling the pores at the boundary. The binder in the electrode layer may be styrene-butadiene rubber or polyvinylidene fluoride.

A method involves applying a non-solvent to the surface of a wet electrode layer containing a solvent mixed with active material and binder. The non-solvent is miscible with the solvent but does not dissolve the binder, triggering phase separation and creating nucleation sites where the binder precipitates into shells around the sites. As the binder solidifies, pores remain on the electrode surface. Following this application, the pores are initially filled with a mixture of the solvent and non-solvent, which is later removed through a drying process. The application of the non-solvent may be performed by spraying, with anisole as the solvent and acetone as the non-solvent. The binder used in the electrode layer may be either styrene-butadiene rubber or polyvinylidene fluoride.

An electrode includes a layer composed of active material and binder, where the binder forms shell-like structures that define voids at the surface of the layer. The binder may be either styrene-butadiene rubber or polyvinylidene fluoride.

### DETAILED DESCRIPTION

Detailed embodiments are provided below. These embodiments are intended solely as examples and may take various alternative forms and configurations. The accompanying figures are not drawn to scale. Certain features may be exaggerated, minimized, or omitted to highlight specific details of particular components. Consequently, the structural and functional details described herein are not to be interpreted as limiting but rather as illustrative examples to guide those skilled in the art in applying the described concepts in different ways.

In one method of solid-state cell manufacturing, a solid electrolyte separator is laminated onto the electrodes, and the laminated layers are subsequently densified to affect interfacial contact. Proper contact between the electrode layers is of interest, as it affects internal resistance, which in turn influences cell performance, particularly at higher discharge rates. Densification also helps eliminate void spaces at the interface, reducing lithium dendrite growth, which can propagate and affect the cell’s lifespan.

Surface contact between layers can be affected by laminating them at high pressures and temperatures, but this approach presents challenges in large-scale solid-state battery manufacturing. One proposed method to enhance interlayer contact is roughening the surfaces before lamination to increase the effective contact area. This, however, conflicts with the need for densification through calendaring, which compresses the layers to affect mechanical integrity.

To address this, some approaches involve using roughened or embossed calendars during the densification process. This method, however, introduces a significant drawback: electrode material can accumulate in the textured features of the equipment. If not properly cleaned, these packed regions can transfer irregular and uncontrolled surface features onto subsequent electrode layers.

A surface modification technique has been developed to reduce the processing conditions required for effective interfacial contact between the separator and electrodes during lamination. The proposed method involves etching the coating surfaces using a phase inversion technique, where the still-wet electrode coating is exposed to a non-solvent that is miscible with the solvent in the slurry but does not dissolve the binder. As solvent exchange occurs, the binder-containing slurry precipitates once the amount of non-solvent exceeds the binder’s solubility limit. At this point, the precipitating slurry develops a sponge-like morphology at the surface, increasing roughness and promoting interlocking between layers during lamination. This modification promotes interfacial contact between solid-state battery layers, potentially affecting mechanical integrity and performance.

In this process, a freshly coated or wet electrode layer, including a solvent mixed with active material, binder, and possibly other additives, exits the coating station, and is exposed to a fluid spray head. The spray head sequentially applies a non-solvent for the binder that is miscible with the slurry solvent. This exposure triggers spinodal decomposition, a phase separation phenomenon where solvent and non-solvent exchange creates metastable nucleation sites on the surface. As the binder precipitates, it forms shells around these nucleation sites, leading to localized solid-phase growth. Under carefully selected solvent and non-solvent conditions, this process progresses from isolated nuclei in regions where the non-solvent amount temporarily exceeds the binder’s solubility limit. The solidification of the binder results in the formation of pores, initially filled with a solvent and non-solvent mixture but devoid of solid components. Upon drying, the solvent and non-solvent evaporate, leaving an etched electrode surface characterized by pores that enhance surface morphology and interfacial adhesion.

When the spray head applies the non-solvent that is miscible with the slurry solvent but does not dissolve the binder, a rapid solvent exchange process begins at the surface of the wet electrode coating. This exchange perturbs the local thermodynamic equilibrium, leading to the spinodal decomposition. Unlike nucleation and growth, which require energy to form distinct phase boundaries, spinodal decomposition occurs spontaneously when the system enters a region of negative diffusivity in the phase diagram, meaning that small composition fluctuations naturally amplify rather than dissipate. In this case, the introduction of the non-solvent reduces the solvent’s ability to maintain the binder in a dissolved state, resulting in an instantaneous shift in solubility conditions.

As the non-solvent diffuses into the slurry and the solvent diffuses outward, regions of locally high non-solvent amounts form, particularly near the surface where the spray first interacts with the wet coating. When the non-solvent amount surpasses the critical solubility threshold of the binder, phase separation begins, leading to the spontaneous formation of metastable nucleation sites. These sites serve as focal points for binder precipitation, where the polymer chains aggregate due to their reduced solubility in the mixed solvent system. Because the phase separation is driven by diffusional instability rather than classical nucleation, the binder does not form discrete droplets but rather a continuously evolving structure with interconnected domains.

As the solvent continues to be displaced by the non-solvent, the binder precipitates around these nucleation sites, forming a shell-like structure that encapsulates the local phase-separated regions. The solidification kinetics of the binder depend on the rate at which the non-solvent displaces the solvent, as well as the specific intermolecular interactions between the binder, solvent, and non-solvent. If the solvent-non-solvent exchange occurs rapidly, the binder precipitates abruptly, leading to the formation of porous structures with well-defined boundaries. Conversely, if the process occurs more gradually, the binder may coalesce into larger, less uniform domains before solidifying.

The final structure of the precipitated binder is highly dependent on the solvent-non-solvent interaction parameters, including their relative miscibility and diffusivity, as well as the rate at which the non-solvent is introduced. In regions where the non-solvent amount temporarily exceeds the binder’s solubility limit, the binder aggregates into distinct solid domains, creating isolated nuclei. These nuclei continue to grow and merge as additional binder precipitates, forming an interconnected network that eventually stabilizes into a solid framework. The spaces between these binder-rich regions remain filled with a transient mixture of solvent and non-solvent, but as the drying process progresses, both volatile components evaporate, leaving behind a porous structure with voids where the liquid phase was previously present. These voids, or pores, are a direct consequence of the phase separation process, as the binder is unable to redistribute once it has solidified, locking in the morphology determined during the initial precipitation phase.

An example of this method in solid-state battery systems involves using styrene-butadiene rubber (SBR) as the binder and anisole as the solvent, with acetone introduced as the non-solvent. Since anisole is miscible with acetone but SBR has limited solubility in acetone, phase separation can occur, leading to the desired surface roughening effect. This approach provides a structured method for modifying electrode surfaces in a way that affects interfacial contact without relying on high pressures and temperatures during lamination.

To analyze the etched surface of an electrode and determine whether it was formed through the described phase inversion and spinodal decomposition process, several characterization techniques could be used. One method would be scanning electron microscopy (SEM), which provides high-resolution imaging of the surface morphology. SEM imaging, particularly in secondary electron mode, would reveal a network of voids with a characteristic interconnected structure, indicative of the non-solvent-induced phase separation. To quantify the spatial distribution of binder around these voids, energy-dispersive X-ray spectroscopy (EDS) can be integrated with SEM to map the elemental composition of the electrode surface. Since binders such as polyvinylidene fluoride (PVDF) or SBR contain distinct elements, such as fluorine in PVDF or specific carbon signatures in SBR, EDS mapping would highlight whether the binder amount is elevated around the perimeters of the voids.

Transmission electron microscopy (TEM) combined with electron energy loss spectroscopy (EELS) can further provide nanoscale insights into the binder distribution. In cross-sectional TEM imaging, sample preparation using focused ion beam (FIB) milling would be required to expose a thin section of the electrode, allowing for a detailed view of how the binder has redistributed around the pores. EELS spectra can detect variations in bonding environments, confirming whether the polymer binder forms dense shells around the voids or remains uniformly distributed across the surface. Additionally, atomic force microscopy (AFM) in phase contrast or tapping mode could be used to assess surface roughness variations introduced by the etching process, as an electrode subjected to this type of etching would exhibit a more irregular topography compared to a conventionally dried electrode.

X-ray photoelectron spectroscopy (XPS) can further validate the presence of binder accumulation at the void perimeters by analyzing the surface chemistry at different regions of the electrode. By comparing spectra obtained from areas immediately surrounding the voids to those in binder-poor regions, XPS can detect an elevated amount of polymer-specific elements at the edges of the pores. Similarly, Raman spectroscopy with spatial mapping capabilities would allow for the detection of molecular fingerprints of the binder and confirm whether there is an increased presence at the void boundaries compared to adjacent regions.

If the process described has been used to create the voids, the results may show that the binder amount is preferentially elevated at the perimeters of the pores rather than being uniformly distributed across the electrode. SEM-EDS mapping would reveal elevated signals corresponding to the binder elements around the void edges, and TEM cross-sections would show the formation of a binder-rich shell-like structure encasing the pores. AFM would indicate an increase in localized surface roughness, and XPS and Raman spectroscopy would confirm the chemical composition variations that arise due to binder migration and precipitation during the solvent exchange process. The presence of these indicators would indicate that the electrode underwent the specific etching mechanism described, distinguishing it from an electrode where voids were formed through mechanical compression, evaporation-driven phase separation, or other structuring techniques.

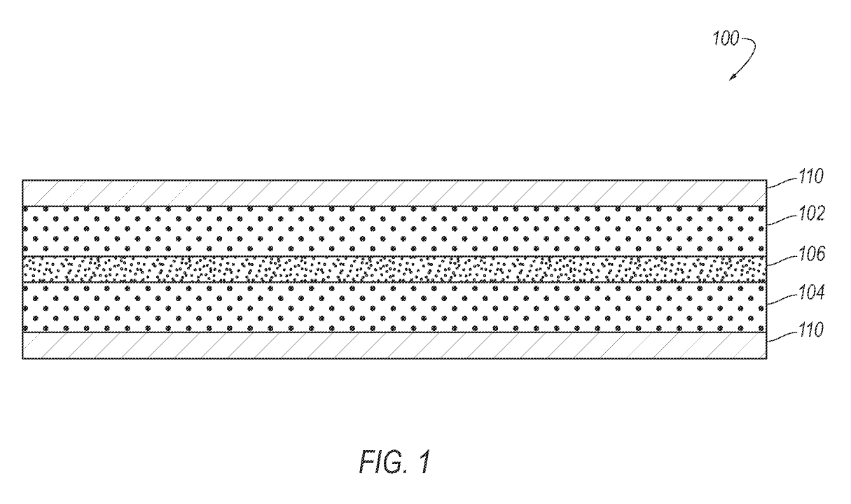

FIG. 1 illustrates a solid-state battery cell 100, which may be a secondary or rechargeable battery (e.g., a lithium-based solid-state battery). The battery cell 100 includes a negative electrode 102, a positive electrode 104, and a solid electrolyte layer 106, which functions as both the electrolyte and the separator. However, the battery 100 may include additional components or may not require all the components shown, depending on the battery type or configuration. In addition, a current collector 110 may be disposed on one or both of the negative electrode 102 and positive electrode 104. In at least one embodiment, the current collector 110 is a metal or metal foil. In one embodiment, the current collector 110 is formed of aluminum or copper. Examples of other suitable metal foils may include, but are not limited to, stainless steel, nickel, gold, or titanium.

Solid-state battery negative electrodes may be formed of carbonaceous materials, such as graphite (natural, artificial, or surface-modified natural), hard carbon, soft carbon, or silicon-enriched graphite. Non-carbonaceous negative electrodes may also be used, such as lithium titanate oxide (LTO), silicon and silicon composites, and lithium metal. Lithium metal is particularly relevant for solid-state batteries, as solid electrolytes can suppress dendrite formation to some extent, though achieving long-term stability remains a challenge. The use of lithium metal requires an electrolyte with high mechanical strength, high ionic conductivity, and chemical stability to prevent lithium dendrite growth and unwanted side reactions at the electrolyte interface. Nickel oxide (NiO) has been investigated for thin-film solid-state batteries but is less common in bulk solid-state cells.

Solid-state battery positive electrodes may include lithium nickel cobalt aluminum oxide (NCA), lithium nickel manganese cobalt oxide (NMC), lithium manganese spinel oxide (Mn Spinel or LMO), lithium iron phosphate (LFP) and its derivatives such as lithium mixed metal phosphate (LFMP), or sulfur-based materials (e.g., sulfur-carbon composites). Additionally, mixtures of two or more of these materials may be used. These electrode materials are merely examples. Any electrode materials known in the art may be used.

Unlike conventional lithium-ion batteries that utilize a liquid electrolyte, solid-state batteries employ a solid electrolyte layer as alluded to above, which enables ionic conductivity while also serving as an electrically insulating separator. Solid electrolytes may be composed of ceramic, polymer, or composite materials. Examples of ceramic solid electrolytes include lithium phosphorus oxynitride (LiPON), garnet-based electrolytes such as lithium lanthanum zirconium oxide (LLZO), and sulfide-based materials such as lithium argyrodite (e.g., Li6PS5Cl). Sulfide-based electrolytes offer high ionic conductivity and good processability but require careful handling due to their sensitivity to moisture. Polymer-based solid electrolytes may include polyethylene oxide (PEO)-based systems, which typically require the addition of lithium salts such as lithium bis(trifluoromethanesulfonyl)imide (LiTFSI) to enhance ionic transport. Composite electrolytes, which incorporate ceramic fillers into a polymer matrix, are also widely studied to affect both ionic conductivity and mechanical stability while maintaining the flexibility needed for large-scale manufacturing.

Electrode production may involve casting a slurry onto a current collector, followed by drying to form an electrode. The slurry may include an active material, a conductive additive, a binder, and a solvent. During casting, the slurry is spread evenly onto the current collector to promote uniform electrode formation.

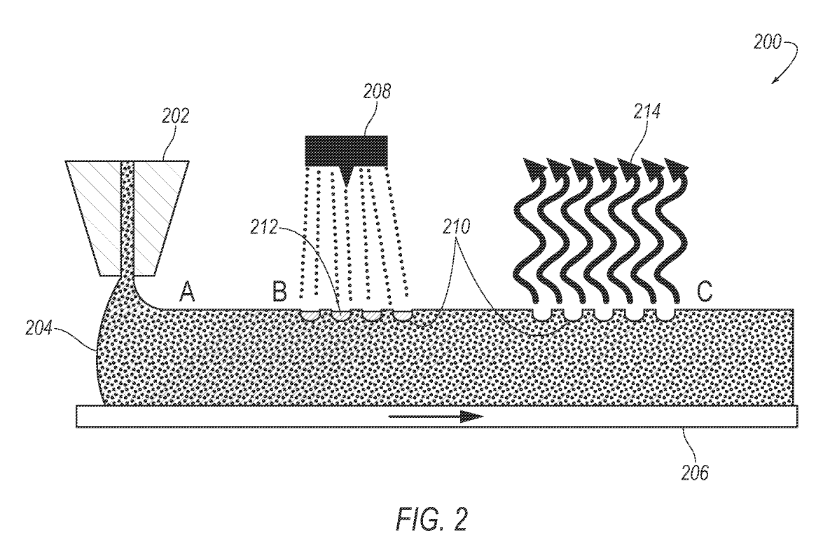

FIG. 2 illustrates a surface modification process 200 for creating an etched surface on an electrode or separator. In one embodiment, this etching occurs during the coating stage using a phase inversion technique. A coating applicator 202 deposits a slurry 204 onto a substrate 206, forming a wet electrode layer.

The slurry 204 includes a binder, an active material, and a solvent that dissolves the binder (referred to as the “solvent material”). As the slurry 204 moves along a manufacturing line, it is exposed to different processing steps and may be transported by a conveyor or other suitable mechanisms. Positioned downstream of the coating applicator 202, a spray head 208 applies a material that does not dissolve the binder but is miscible with the solvent material (referred to as the “non-solvent material”). This exposure initiates spinodal decomposition, causing phase separation and the formation of random metastable nucleation sites on the slurry surface.

As solvent-non-solvent exchange continues, phase separation progresses, leading to the formation of pores 210 on the coated layer’s surface. These pores 210 are initially filled with a mixture of solvent and non-solvent 212 as the binder precipitates and structures itself around the nucleation sites. The system then undergoes a drying step 214, during which the solvent and non-solvent mixture evaporates from the pores 210, leaving behind a stable, porous surface. This controlled drying process results in a modified structure that remains intact and does not deform.

The processes described above for etching the surface of an electrode or separator may be controlled by a computer system that includes a processor and memory. This computer system can be configured to issue commands to various components within the battery manufacturing system, such as the coating applicator 204, spray head 208, and any material transport mechanisms. For example, the computer may actuate a conveyor to move the coated layer along the manufacturing line, control the deposition of the slurry 204 through the coating applicator 202, and manage the spray head 208 to apply the non-solvent material as needed.

The computer system includes a processor and memory, where the memory comprises one or more types of computer-readable media storing executable instructions. These instructions enable the system to perform various automated operations, including those described herein. The computer may be a general-purpose machine with a processor and memory or may include specialized components such as an electronic control unit (ECU) designed for specific functions. Additionally, the system may incorporate dedicated electronic circuits such as an application-specific integrated circuit (ASIC), which is pre-designed for a particular operation, such as processing sensor data or coordinating manufacturing processes. In some implementations, the computer may include a field-programmable gate array (FPGA), an integrated circuit that allows users to configure its logical components after manufacturing. FPGA programming is typically carried out using a hardware description language such as very high-speed integrated circuit hardware description language (VHDL). While ASICs are fabricated based on pre-manufacturing VHDL programming, FPGAs can be dynamically reconfigured using VHDL stored in memory. In some cases, the system may utilize a combination of processors, ASICs, and FPGAs to achieve optimal performance. Furthermore, the computer system may consist of multiple interconnected computing devices working together.

The memory used by the computer system can take various forms, including hard disk drives, solid-state drives, and remote storage servers. It may be implemented as volatile or non-volatile storage, depending on system requirements. In some implementations, the memory is a separate device from the computer, and the system retrieves stored data over a communications network such as a controller area network (CAN) bus or a wireless network. Alternatively, the memory may be directly integrated into the computer as onboard storage.

The computer system can be communicatively linked to various components through a communication network, enabling data exchange and process coordination. This network may include wired and wireless communication mechanisms, such as a CAN bus or other industrial communication protocols. If the system consists of multiple computing devices, the network facilitates inter-device communication to synchronize operations across the manufacturing process.

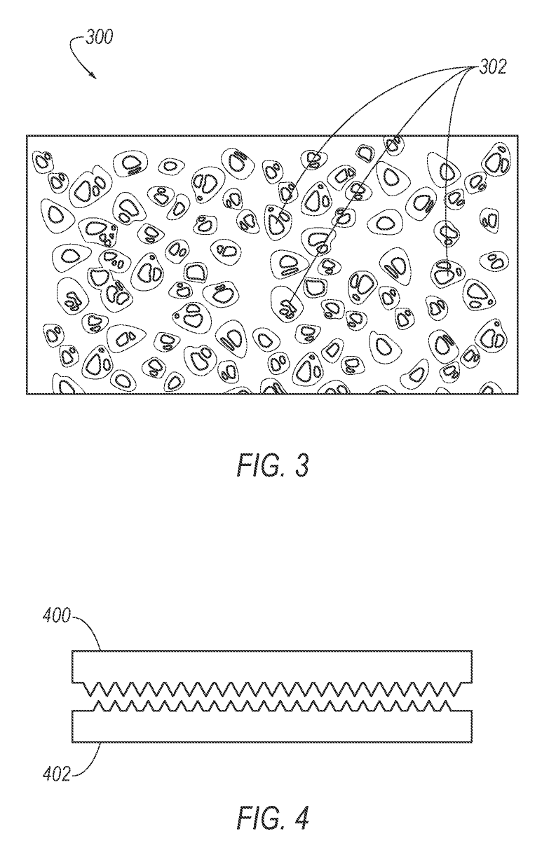

FIG. 3 is an image of an electrode 300 after precipitation of the binder and drying as described above. Pores 302 are apparent in the surface thereof.

FIG. 4 shows a separator 400 and electrode 402 having boundaries etched as described herein prior to lamination.

Although the steps or stages of the described processes have been presented in a particular sequence, the processes may be performed in a different order than specified. Additionally, certain steps may be executed simultaneously, additional steps may be introduced, or some of the described steps may be omitted. The process descriptions provided herein are intended to illustrate certain embodiments and should not be interpreted as limiting the scope of the claims.

While example embodiments have been described above, they are not intended to encompass all possible variations. The terminology used in this specification serves a descriptive purpose rather than a restrictive one, and modifications may be made without departing from the broader scope and principles disclosed. Furthermore, features from different embodiments may be combined to create additional implementations within the scope of the claims.

What is claimed is:

1. A battery comprising:
an electrode layer, including active material and binder, with a boundary defining a plurality of pores and having elevated amounts of the binder at edges of the pores relative to other areas of the electrode layer; and
a separator laminated with the electrode layer at the boundary such that portions of the separator at least partially occupy portions of the pores.

2. The battery of claim 1, wherein the binder is styrene-butadiene rubber.

3. The battery of claim 1, wherein the binder is polyvinylidene fluoride.

4. A method comprising:
applying, to a surface of a wet electrode layer that includes a solvent mixed with active material and binder, a non-solvent for the binder that is miscible with the solvent to create nucleation sites on the surface such that the binder precipitates into shells around the nucleation sites and, as the binder solidifies, pores remain at the surface.

5. The method of claim 4, wherein after the applying, the pores are filled with a mixture of the solvent and non-solvent.

6. The method of claim 5 further comprising drying the wet electrode layer to remove the mixture from the pores.

7. The method of claim 4, wherein the applying includes spraying.

8. The method of claim 4, wherein the solvent is anisole.

9. The method of claim 4, wherein the binder is styrene-butadiene rubber.

10. The method of claim 4, wherein the binder is polyvinylidene fluoride.

11. The method of claim 4, wherein the non-solvent is acetone.

12. An electrode comprising:
a layer, of active material and binder, having shells of the binder define voids at a surface of the layer.

13. The electrode of claim 12, wherein the binder is styrene-butadiene rubber.

14. The electrode of claim 12, wherein the binder is polyvinylidene fluoride.
